(19) United States
(12) Patent Application Publication
(10) Pub. No.: US 2003/0088472 A1
(43) Pub. Date: May 8, 2003

(54) Methods, systems, and articles of manufacture for providing product availability information

(75) Inventors: Joseph Offutt, Grapevine, TX (US); Tony J. Brice, Colleyville, TX (US); Alan Walker, Southlake, TX (US); Barry C. Smith, Flower Mound, TX (US)

Correspondence Address: Guy R. Gosnell, Esq., Alston & Bird LLP, Bank of America Plaza, 101 South Tryon Street, Suite 4000, Charlotte, NC, 28280-4000, US

(73) Assignee: Sabre Inc.

(21) Appl. No.: 10/286,891

(22) Filed: Nov. 4, 2002

Related U.S. Application Data
(60) Provisional application No. 60/330,953, filed on Nov. 5, 2001.

(51) Int. Cl. G06F 17/60

(52) U.S. Cl. 705/22

(57) ABSTRACT

Methods and systems consistent with certain aspects related to the invention provide product availability information to a requestor via a proxy computer. In one aspect, a proxy computer that acts on the behalf of a seller computer receives product inventory information and one or more inventory control rules provided by the seller computer. In response to an availability request provided by a user, the proxy computer may determine product availability information based on the product inventory information and the one or more inventory control rules. Further, the proxy computer may be configured to update at the product inventory information and/or one or more control rules based on a determination that the seller computer has updated the same information stored in a database.

### CROSS REFERENCE TO RELATED APPLICATION

This application is related to and claims the benefit of priority under 35 U.S.C. 119(e) to U.S. Provisional Patent Application No. 60/330,953, filed on Nov. 5, 2001, the disclosure of which is expressly incorporated herein by reference in its entirety.

### BACKGROUND OF THE INVENTION

1. Field of the Invention

The present invention relates generally to providing product availability information, and more particularly, to a system, method, and article of manufacture for providing product availability information via a proxy.

2. Background Information

In recent years, the Internet has experienced explosive growth and success mainly because it provides users with quick access to a vast array of resources through web sites. In fact, many suppliers have started offering their products and/or services (hereinafter collectively referred to as products) via their web sites or through the web sites of intermediaries. For example, an airline may offer airline seats through its own web site or through a travel agent's website. Accordingly, a consumer may access these sites, select and purchase the seats electronically.

Before purchasing a product, however, a consumer normally requests product availability information from the seller (i.e., the supplier or an intermediary). Product availability information may include information about the products that are available and/or pricing information. For example, if the seller is associated with a hotel, product availability information may include the types of rooms that are available and the price information associated with each type of room. If on the other hand the seller is associated with an airline, the product availability information may include information on available seats, such as availability data, fare information, etc.

Similarly, before a seller, such as an airline, sells a product, the seller may also need to determine or obtain product availability information to process a sale. Further, if the seller is an intermediary entity, such as a travel agent, the intermediary may also need to obtain the product availability information from the seller.

As a result of offering products via the Internet, suppliers (i.e., sellers) have realized additional revenue due to, among other things, access to customers distributed throughout the world. Although suppliers benefit from the additional customers obtained through the Internet, they also receive and have to process a proportional amount of requests for product availability information. The increase in the volume of requests has created several problems for suppliers.

One problem is associated with current availability processes that generate the responses to product availability information requests. In some instances, the high volumes of requests that are being generated through the Internet, as well as through conventional means (e.g., telephone sales), cannot be efficiently handled by these current processes. Further, most of the current availability processes run on platforms that cannot be inexpensively scaled to support the increase in the volume of requests.

Another problem with current product availability processes is that the suppliers and/or intermediaries may not be able to use modern heuristic tools for determining inventory and managing yield when generating a response to a request for product availability information because of software and hardware limitations. Such heuristic tools may implement one or more rules that a supplier may use to control its product inventory, such as a rule for controlling discounts provided to customers based on a type of purchase request. For example, although an airline may use origin, destination, and point of sale information (e.g., agency/partner identification number and frequent flyer identification number) to generate a response to a flight availability request, due to the limitations of conventional product availability systems, the airline may not be able to use this information to process every availability request received by one or more consumers.

To address the shortcomings associated with conventional product availability systems, suppliers and/or intermediaries may implement response storage and retrieval techniques. This technique involves storing generated responses for corresponding availability requests and retrieving the stored response to process subsequent identical requests. Although storage and retrieval techniques enable a supplier and/or intermediary to reduce the processing resources required to handle increasing availability requests, the information includes in the stored responses may not be up to date and thus, may misrepresent information to a customer. This misrepresentation may result in disappointed customers and subsequently reduced sales.

### SUMMARY OF THE INVENTION

Methods, systems, and articles of manufacture consistent with certain aspects related to the present invention overcome the shortcomings of conventional availability systems by providing product availability information to a requester via a proxy device. For example, such methods, systems, and articles of manufacture may be associated with one or more proxy computers that receive and store product inventory information and one or more inventory control rules provided by a seller computer. The one or more proxy computers may be configured to intercept (i.e., receive) a request for product availability information from a requester and generate a corresponding response based on the stored product inventory information and the one or more inventory control rules and/or rule parameters. In one aspect of the invention, the seller computer may provide the product inventory information and the one or more inventory rules to the one or more proxy computers on a real-time or periodic basis.

### BRIEF DESCRIPTION OF THE DRAWINGS

The accompanying drawings are incorporated in and constitute a part of this specification, and together with the description, explain the principles of the invention. In the drawings:

FIG. 1 illustrates an exemplary system environment, consistent with certain aspects related to the present invention;

FIG. 2 is a block diagram of an exemplary inventory computer, consistent with certain aspects related to the present invention;

FIG. 3 is a block diagram of an exemplary events computer, consistent with certain aspects related to the present invention;

FIG. 4 is a block diagram of an exemplary proxy computer, consistent with certain aspects related to the present invention;

FIG. 5 is a flowchart showing an exemplary update process, consistent with certain aspects related to the present invention;

FIG. 6 is a flowchart showing an exemplary events process, consistent with certain aspects related to the present invention;

FIG. 7 is a flowchart showing an exemplary proxy update process consistent with certain aspects related to the present invention; and

FIG. 8 is a flowchart showing an exemplary availability process, consistent with certain aspects related to the present invention.

### DETAILED DESCRIPTION

### Overview

The following detailed description of the invention refers to the accompanying drawings. While the description includes exemplary embodiments, other embodiments are possible and changes may be made to the embodiments described without departing from the spirit and scope of the invention. The following detailed description does not limit the invention. Instead, the appended claims and their equivalents define the scope of the invention.

Methods, systems, and articles of manufacture consistent with certain aspects related to the present invention provide product availability information to one or more users via one or more proxy computers. In one aspect of the invention, a supplier computer may provide product inventory information to the one or more proxy computers on a real-time or a periodic basis. Moreover, the supplier computer may update the inventory information stored in the one or more proxy computers as the inventory information changes on the supplier computer. This updating may also be performed on a real-time or a periodic basis. Further, the supplier computer may provide adjustments to one or more control rules that may be stored at the one or more proxy computers on a real-time or a periodic basis.

Based on the received information provided by the supplier computer, a proxy computer may generate a response to a product availability request received by a user. For example, a user may generate a product availability request at a computer system operated by the user. The request may be provided directly to a proxy computer. Alternatively, the request may be provided to the supplier computer where it is automatically routed to one or more of the proxy computers. Based on the received request, inventory data, and/or one or more control rules, the proxy computer may generate and send an availability response to the user.

### Exemplary Computing Environments

Reference will now be made in detail to the exemplary aspects of the invention, examples of which are illustrated in the accompanying drawings. Wherever possible, the same reference numbers will be used throughout the drawings to refer to the same or like parts.

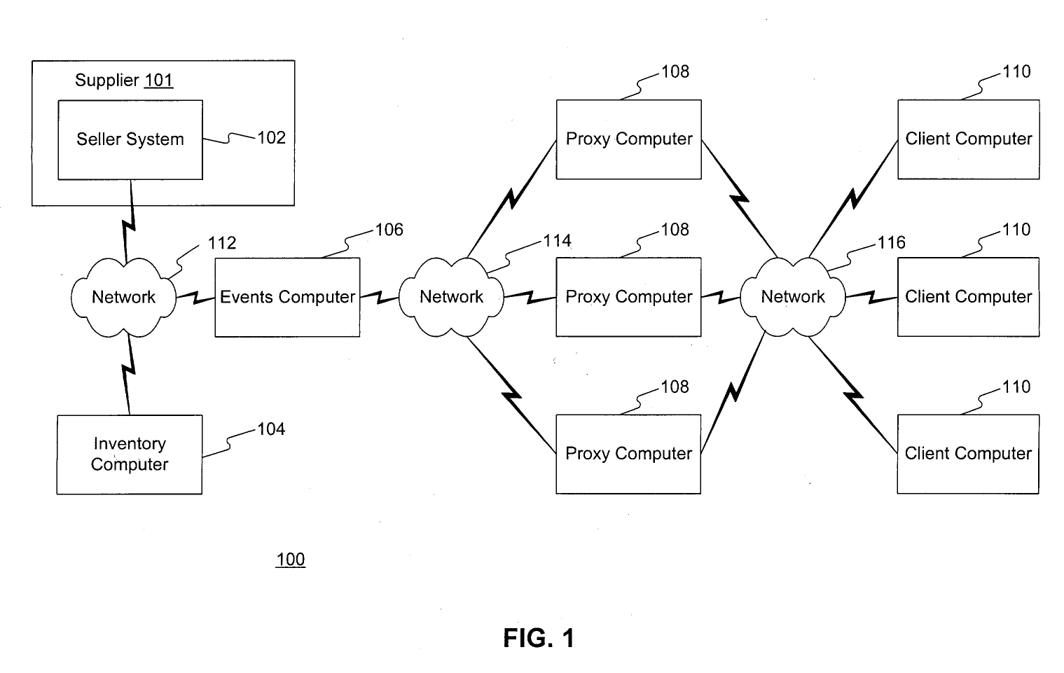

FIG. 1 is a block diagram of an exemplary computing system 100, consistent with certain aspects related to the present invention. As shown, system 100 may include networks 112, 114, and 116, a supplier 101, a seller system 102, an inventory computer 104, an events computer 106, one or more proxy computers 108, and one or more client computers 110.

Networks 112, 114, and 116 each may be any type of network capable of transmitting data. For example, networks 112, 114, and 116 may include a Local Area Network, Wide Area Network, combinations of switching or data networks, and the Internet. Furthermore, networks 112, 114, and 116 may process wireline and wireless communications, or a combination thereof, to and from any entity attached thereto. Although FIG. 1 shows networks 112, 114, and 116 as separate entities, one skilled in the art would appreciate that these networks may represent a single network that facilitates communications between the entities included in system 100. Further, each of the entities shown in FIG. 1 may be directly linked to facilitate direct access communications. For example, seller system and inventory computer may be directly linked by a communications channel that enables the direct exchange of information between the two entities. For exemplary purposes, however, system 100 is shown to allow seller system 102, inventory computer 104, and events computer 106 to communicate with each other through network 112. Also, events computer 106 may communicate with proxy computers 108 through network 114 and proxy computers 108 may communicate with client computers via network 116.

Seller system 102 may be one or more known processing devices, such as a mainframe computer, component server, personal computer, workstation, laptop, or any other similar data processing system. In one aspect of the invention, seller system 102 may be associated with a supplier 101 that provides one or more products and configured to provide availability information associated with the one or more products. Supplier 101 may also be an intermediary entity associated with a supplier entity that provides one or more products. Accordingly, one skilled in the art will appreciate that the following description of supplier 101 may applicable to an intermediary entity associated with a supplier entity. A product may be any type of product and/or service that is provided by a business entity (e.g., supplier 101) associated with seller system 102. For example, a product may be an item that this manufactured, developed, marketed, etc. by supplier 101, such as a piece of equipment, article of clothing, etc. Further, a product may be associated with a service, such as air travel, lodging services, vehicle rentals, etc. For example, if supplier 101 is associated with an airline, seller system 102 may include the infrastructure that may be used to reserve, sell, and/or book seats for air travel. Further, seller system 102 may provide a look and book service, which is a service that enables a user to “look” (e.g., browse, inquire, etc.) for information regarding available products offered by supplier 101 (and possibly others suppliers) and “book” (e.g., reserve, complete purchase transaction, etc.) a product selected by the user. For exemplary purposes, seller system 102 is described herein as being associated with an airline, thus providing products associated with air travel. One skilled in the art will appreciate that the following description associated with the exemplary air travel products is exemplary and may be applied to any type of product that may be provided by a corresponding business entity within or outside the travel industry.

Inventory computer 104 may be one or more known processing devices, such as a mainframe, computer server, personal computer, workstation, laptop, or any other similar data processing system. In one aspect of the invention, inventory computer 104 may store and maintain product inventory information and inventory control rules provided by seller system 102. In one aspect of the invention, seller system 102 and inventory computer 104 may be combined into a single data processing system. For example, a seller program executed by a data processing system may interact with an inventory program executing in the same data processing system. Alternatively, the functions performed by seller system 102 and inventory computer 104 may be merged into a single process or data processing system to perform their respective functions as a single processing component.

The product inventory information, control rules and/or control rule parameters may be accessed and modified by supplier 101 through seller system 102. Product inventory information, as the term used herein, may include information associated with one or more products provided by supplier 101. For example, product inventory information may reflect the number and type of products provided by supplier 101. Further, product inventory information may reflect characteristics associated with these products, such as price, availability, identification data, etc. (e.g., serial numbers, flight information, seat availability on a flight, etc.) Product inventory information may include information reflecting available seats on an airline flight between two locations (e.g., two connecting leg cities or origination and destination cities). In one aspect of the invention, product inventory information reflects information associated with a travel related service, such as an airline flight, a ship voyage, a train trip, a bus trip, a limousine trip, a lodging service (e.g., hotel), and any other type of travel related service. Further, product availability information, as the term is used herein, may reflect information associated with one or more available opportunities to receive the travel related service, such as available seats on an airline flight or available rooms in a hotel, etc. One skilled in the art will appreciate that travel related products, such as airline seats or hotel rooms, may reflect virtual inventory items because these products may not have an associated serial or identification number as a tangible product may have (e.g., a physical product such as an item of manufacture). Accordingly, the travel-related products (e.g., airline seats, hotel rooms, etc.) may be associated with a class or type of product rather than an individual product. However, methods, systems, and articles of manufacture consistent with certain aspects related to the present invention may associate a travel-related product with an individual virtual inventory product, such as a particular airline seat on a particular flight.

A control rule, as the term is used herein, may be logic (e.g., software based logic) that controls an action or function performed by a corresponding data processing system implementing the rule. For example, a control rule may be associated with the products corresponding to the product inventor information stored in inventory computer 104. For example, if supplier 101 is an airline, an exemplary control rule may include logic that controls the price of an available airline seat on a flight based on revenue generated from previous sold seats for that flight. Thus, the exemplary logic may determine whether the revenue associated with a number of seats sold for a particular flight is less than the cost of providing the flight by the supplier. Based on the determination, the exemplary logic may enable a process implementing the control rule to adjust the price of any remaining available seats on the flight to compensate for any difference between the cost of the flight and the determined revenue. Further, each control rule may include one or more parameters, such as a variable, that is used to direct the rule. For example, a control rule may include logic that directs a process to perform a certain function when a particular value of a first parameter is within a predetermined range of values of a second parameter (e.g., threshold value).

Events computer 106 may be one or more processing devices, such as a mainframe computer, client computer, personal computer, workstation, laptop, personal digital assistant, or any other similar data processing system. In one aspect of the invention, events computer 106 may receive information associated with updates to product inventory information and inventory control rules from inventory computer 104 and send corresponding information about these updates to proxy computers 108. Further, events computer 106 may receive information from proxy computers 108 indicating stale or out of date information and forward this information to inventory computer 104 and/or seller system 102 via network 112.

Proxy computers 108 may be one or more processing devices, such as a mainframe computer, client computer, personal computer, workstation, laptop, personal digital assistant, or any other similar data processing system. In one aspect of the invention, proxy computers 108 may each receive and locally store a copy of the product inventory information and the inventory control rules stored on inventory computer 104. Further, proxy computers 108 may each receive one or more requests for product availability information, generate a corresponding response based on the locally stored product inventory information and inventory control rules, and provide the response to requesters that generated the availability requests.

Client computers 110 may each be one or more processing device, such as a mainframe computer, client computer, personal computer, workstation, laptop, personal digital assistant, or any other similar data processing system. Each client computer 110 may be operated by one or more users that may represent a buyer or purchaser of the products provided by supplier 101. For example, a user of client computer 110 may be a travel buyer, such as a passenger, and a travel service provider, such as a travel agent or an agent associated with a travel service provider (e.g., an airline employee). It should be noted that these examples are not intended to be limiting and one skilled in the art would realize that client computers 110 may each be operated by a number of different types of users without departing from the scope of the invention. In one aspect of the invention, a user may use a client computer 110 to request product availability information from proxy computers 108 and or seller system 102. Each client computer 110 may execute browser software, such as Internet Explorer or Netscape Navigator, that enable a user to locate a computer system (e.g., proxy computer 108), request product availability information, and receive a corresponding response. Further, client computers 110 may perform a process executed by a data processing device that automatically generates and provides a product availability request to a proxy computer 108 and/or seller system 102. For example, a client program executed by a client computer 110 may request product availability information as a step or sub-step in the client program.

Other system and network configurations will be apparent to those skilled in the art and are also within the scope of the present invention. For example, a single computer system may perform the functions performed by seller system 102, inventory computer 104, and events computer 106. As a result, seller system 102 may include the inventory information and inventory control rules information instead of providing this information to inventory computer 104. Likewise, it will be apparent to one skilled in the art that seller system 102 and inventory computer 104 may be used to sell products of several suppliers 101. Moreover, it will be apparent to one skilled in the art that the entities shown in FIG. 1 may use various communication protocols, such as Hypertext Transport Protocol (HTTP) and Transmission Control Protocol/Internet Protocol (TCP/IP) to communicate with other remote entities.

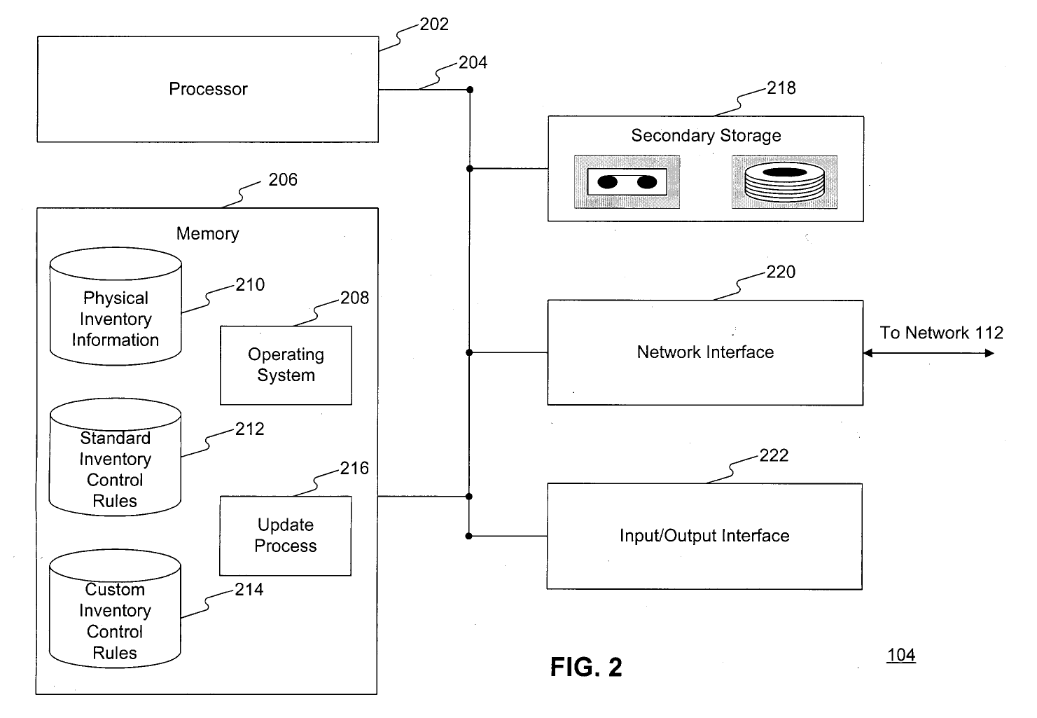

FIG. 2 is a block diagram of exemplary inventory computer 104, consistent with certain aspects related to the present invention. As shown, inventory computer 104 may include a processor 202, which connects via a bus 204 to a memory 206, a secondary storage 218, a network interface 220, and an input/output interface 222.

Processor 202 may be one or more processing devices, such as a microprocessor, configured to execute instructions and perform processes consistent with certain principles related to the present invention. Although FIG. 2 shows only one processor 202, one skilled in the art would appreciate that a number of different architectures may be implemented by methods, systems, and articles of manufacture consistent with certain features related to the present invention. For example, processor 202 may be replaced, or supplemented, by a plurality of processors that perform multi-tasking and/or multi-processing operations.

Memory 206 may be may be any known type of storage device and/or system that stores data. Memory 206 may include, but is not limited to, magnetic, semiconductor, and/or optical type storage devices. Memory 206 may include a storage device that allows processor 202 quick access to data, such as a cache memory. In one configuration consistent with selected features related to the present invention, memory 206 may store data and/or program instructions to implement methods consistent with certain features related to the present invention. For example, as shown in FIG. 2, memory 206 includes an operating system 208, a physical inventory information database 210, a standard inventory control rules database 212, a custom inventory control rules database 214, and an update process 216. Memory 206 may also include, or be associated with, a database management system (not shown).

Databases 212, 214, and 216 may each be any type of database, such as an object-oriented or relational database. One skilled in the art will appreciate that the type of databases included in memory 206 may vary based on the configuration of inventory computer 104 (e.g., hardware components, operating system, etc.). Physical inventory information database 210 may include product inventory and pricing information associated with one or more products provided by supplier 101. For example, database 210 may include information on a number of available products provided by supplier 101, the cost of each product, and any other type of descriptive information related to the available products.

Standard inventory control rules database 212 may include one or more standard rules for controlling inventory (e.g., products provided by supplier 101). A standard rule may be associated with a generic business rule, such as increasing the price of a product when a demand for the product is rising. Inventory computer 104 may be configured to generate and maintain one or more standard rules in database 212. Alternatively, inventory computer 104 may receive one or more standard rules from seller system 102 and store the received rules in database 212.

Custom inventory control rules database 214 may include custom rules for controlling inventory, such as discounts on products during a special situation determined by seller system 102 and/or supplier 101. For example, supplier 101 determine that a sale on one or more of its products should be implemented for a predetermined period of time. Seller system 102 may generate a custom rule that reduces the price for each of the products on sale and provides the rules to inventory computer 104 for storage in database 214.

Alternatively, or additionally, seller system 102 may adjust one or more parameters associated with a standard and/or custom control rule stored in databases 212 and 214, respectively. For example, seller system 102 may provide a new threshold value for a seat availability rule that adjusts the price of an available seat on a particular airline flight offered by supplier 101.

Update process 216 may represent stored instructions in the form of software, which are executed by processor 202 to perform an update process consistent with certain embodiments related to the present invention. Update process 216 may, when executed by processor 202, monitor databases 210, 212, and 214 to detect any changes to information stored therein, such as additions, deletions, and modifications to a rule or inventory information. Further, update process 216 may collect any detected changes to the information stored in database 210, 212, and/or 214, and format them into one or more update messages that are provided to events computer 106. For example, update process 216 may implement one or more messaging processes, such as MQSeries Messaging or Java Message Service (JMS) to deliver the update messages to events computer 106.

Secondary storage 218 may comprise one or more storage devices, such as a disk drive and/or a tape drive. Inventory computer 104 may use secondary storage to store information received from events computer 106 and seller system 102. Additionally, secondary storage 218 may store information transferred from memory 206. Inventory computer 104 may store information in a tape drive and a disk drive for fault tolerant purposes and provide the stored information to another memory device (e.g., 206) or requesting entity or process.

Network interface 220 may be one or more interface devices that enable inventory computer 104 to exchange information with entities connected to network 112. Accordingly, inventory computer 104 may use interface 220 to transmit and receive data to seller system 102 and/or events computer 106.

Input/Output interface 222 may be one or more interface devices that enable information to be received and provided to a local input/output device, such as a keyboard, key pad, mouse, display unit, printer, etc.

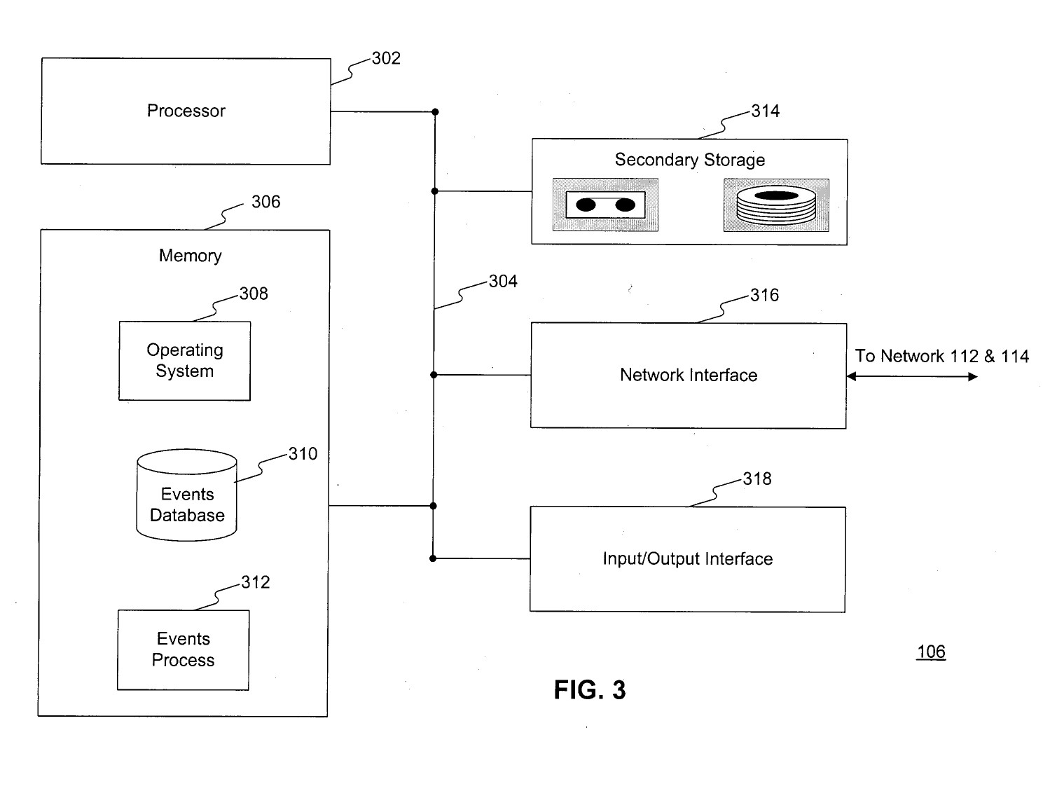

FIG. 3 is a block diagram of an exemplary events computer 106, consistent with certain aspects related to the present invention. Events computer 106 may include a processor 302, which connects via a bus 304 to a memory 306, a secondary storage 314, a network interface 316, and an input/output interface 318.

Processor 302 may be one or more processing devices, such as a microprocessor, configured to execute instructions and perform processes consistent with certain principles related to the present invention. Although FIG. 3 shows only one processor 302, one skilled in the art would appreciate that a number of different architectures may be implemented by methods, systems, and articles of manufacture consistent with certain features related to the present invention. For example, processor 302 may be replaced, or supplemented, by a plurality of processors that perform multi-tasking and/or multi-processing operations.

Memory 306 may be any known type of storage device and/or system that stores data. Memory 206 may include, but is not limited to, magnetic, semiconductor, and/or optical type storage devices. Memory 206 may also include a storage device that allows processor 202 quick access to data, such as a cache memory. In one aspect of the invention, memory 306 includes an operating system 308, an events database 310, and an events process 312. Memory 306 may also include, or is associated with, a database management system (not shown).

Events database 310 may be any type of database, such as an object-oriented or relational database. In one aspect of the invention, events database 310 may store information associated with changes to information stored in databases 210, 212, and 214 that are provided by inventory computer 104.

Events process 312 may be stored instructions in the form of software, which are executed by processor 302 to perform an events process consistent with certain aspects related to the invention. For example, events process 312 may, when executed by processor 306, receive update messages from inventory computer, and store the information included in the update messages in events database 310. Events process 312 may also generate inventory control events messages, which may include information associated with the updates, and send the inventory control events messages to one or more proxy computers 108.

Secondary storage 314 may comprise one or more storage devices, such as a disk drive and/or a tape drive. Events computer 106 may use secondary storage 314 to store information received from inventory computer 104 and seller system 102. Additionally, secondary storage 314 may store information transferred from memory 306. Events computer 106 may store information in a tape drive and a disk drive for fault tolerant purposes and provide the stored information to another memory device (e.g., 306) or requesting entity or process.

Network interface 316 may be one or more interface devices that enable events computer 106 to exchange information with entities connected to networks 112 and 114. Accordingly, inventory computer 104 may use interface 316 to transmit and receive data to seller system 102, events computer 106, and/or proxy computers 108.

Input/Output interface 318 may be one or more interface devices that enable information to be received and provided to a local input/output device, such as a keyboard, key pad, mouse, display unit, printer, etc.

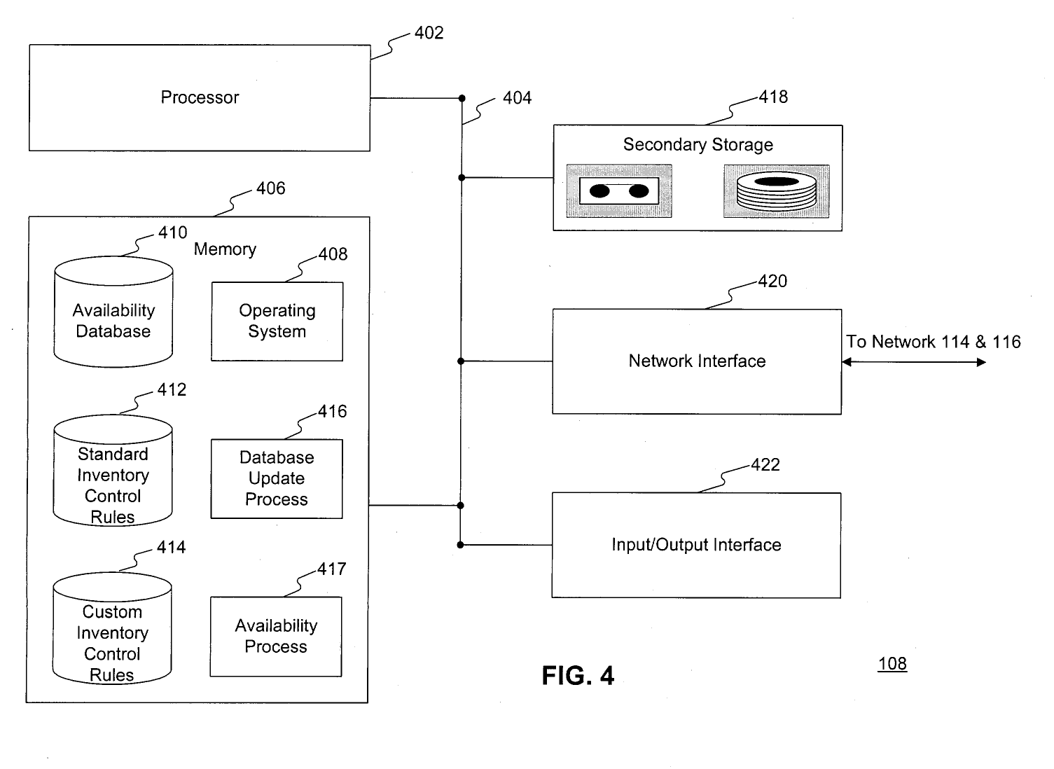

FIG. 4 is a block diagram of an exemplary proxy computer 108, consistent with certain aspects related to the present invention. Proxy computer 108 may include a processor 402, which connects via a bus 404 to a memory 406, a secondary storage 418, a network interface 420, and an input/output interface 422.

Processor 402 may be one or more processing devices, such as a microprocessor, configured to execute instructions and perform processes consistent with certain principles related to the present invention. Although FIG. 4 shows only one processor 402, one skilled in the art would appreciate that a number of different architectures may be implemented by methods, systems, and articles of manufacture consistent with certain features related to the present invention. For example, processor 402 may be replaced or supplemented by a plurality of processors that perform multi-tasking and/or multi-processing operations.

Memory 406 may be any known type of storage device and/or system that stores data. Memory 406 may include, but is not limited to, magnetic, semiconductor, and/or optical type storage devices. Memory 406 may also include a storage device that allows processor 402 quick access to data, such as a cache memory. In one aspect of the invention, memory 406 may include an operating system 408, availability database 410, standard inventory control rules database 412, custom inventory control rules database 414, database update process 416, and availability process 417. Operating system 408 may represent any known type of operating system implemented by proxy computer 108, such as the Solaris operating system, the Linux operating system, or a Windows operating system (e.g., Windows NT).

Availability database 410, standard inventory control rules database 412, and custom inventory control rules database 414 may each be any type of database, such as an object-oriented or relational database. One skilled in the art will appreciate that the type of databases included in memory 406 may vary based on the configuration of proxy computer 108 (e.g., hardware components, operating system, etc.). In one aspect of the invention, databases 410, 412, and 414 may each include a partial or complete copy of the information stored in physical inventory information database 210, standard inventory control rules database 212, and custom inventory control rules database 214, respectively. For example, database 410 may include information associated with the types of available products provided by supplier 101, whereas database 210 may include information about the same products that have been sold and that are available. Database 412 may include the same standard rules stored in database 212 and database 414 may include the same custom rules stored in database 214.

In one aspect of the invention, databases 412 and 414 may include one or more additional and/or different rules from those rules stored in databases 212 and 214, respectively. For example, if supplier 101 is associated with airline that provides air travel services and a proxy computer 108 is located at a travel agent's office, databases 412 and/or 414 may include one or more rules that use travel agency identification, traveler frequent flyer identification numbers, currency, origination and destination information, and/or traveler type to determine product availability information. A travel type may be a category of travelers designated by supplier 101, such as travelers that have a historical tendency of showing and receiving (or not showing and not receiving) a travel-related service. Accordingly, although the above exemplary proxy computer 108 includes the same rules stored in databases 212 and 214, the exemplary travel agent based information may not be stored in databases 212 and 214.

Database update process 416 and availability process 417 may include stored instructions in the form of software, which are executed by processor 402 to perform an update and availability process, respectively. Database update process 416 may receive inventory control event messages from events computer 106 and may update databases 410, 412, and/or 414 based on the information included the received events messages. Availability process 417 may receive one or more requests for product availability information from a client computer 110, generate corresponding responses, and provide the responses to the requesting client computer 110. In one aspect of the invention, availability process 417 may generate an availability response based on the information stored in databases 410, 412, and/or 414. Further, availability process 417 may implement an algorithm provided by seller system 102 to generate an appropriate response to an availability request. For example, if supplier 101 is an airline, availability process 417 may use a yield management algorithm provided by seller system 102 that generates information associated with available travel services.

Secondary storage 418 may comprise one or more storage devices, such as a disk drive and/or a tape drive. Proxy computer 108 may use secondary storage 418 to store information received from events computer 106 and/or client computer 110. Additionally, secondary storage 418 may store information transferred from memory 406. Proxy computer 108 may store information in a tape drive and disk drive included in storage 418 for fault tolerant purposes and provide the stored information to another memory device (e.g., 406), requesting entity and/or process.

Network interface 422 may be one or more interface devices that enable proxy computer 108 to exchange information with entities connected to networks 114 and 116. Accordingly, proxy computer 108 may use interface 422 to transmit and receive data to events system 106, and/or one or more client computers 110.

Exemplary Product Availability Processes

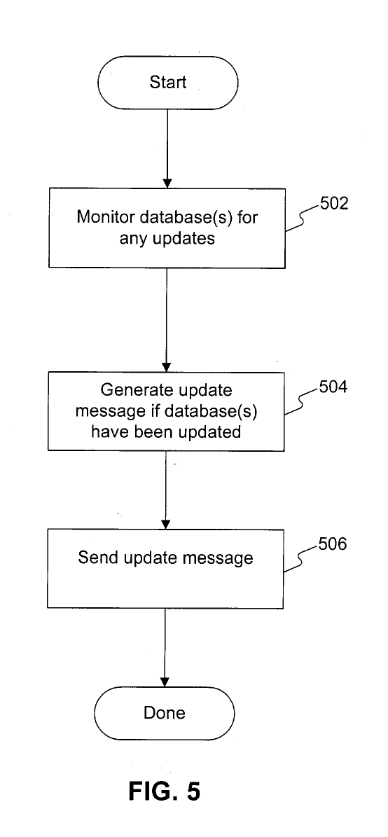

FIG. 5 is a flowchart illustrating an exemplary update process 216 that may be performed by inventory computer 104, in accordance with certain aspects related to the present invention. As shown, the update process 216 may begin by monitoring one or more of databases 210, 212, and 214 to detect any updates (i.e., changes) to the information stored within these databases (step 502). In one aspect of the invention, update process 216 may obtain a snapshot state image of the information included in each of databases 210, 212, and 214. Subsequently, update process 216 may periodically check one or more of databases 210, 212, and 214 to obtain a current snapshot state image of the information included therein. Based on a comparison of the current and previous snapshots, update process 216 may determine whether any information included in any of databases 210, 212, and 214 has changed.

Alternatively, each time seller system 102 changes information in any one of databases 210, 212, and 214, inventory computer 104 may be configured to generate an update trigger signal that notifies update process 216 of a change and the specifics of the change (e.g., identifies what inventory information and/or rule data was modified). Accordingly, in this aspect of the invention, update process 216 may monitor for a trigger signal indicating a change to one of the databases. One skilled in the art will appreciate that update process 216 may perform different techniques to monitor one or more of databases 210, 212, and 214 for any changes without departing from the scope of the present invention. For example, update process 216 may receive a signal from a memory control device that performs a read, write, or erase operation to any of the information included in a corresponding database 210, 212, and 214. The signal may provide update process 216 with the identification of the type of information and the type of change corresponding to the access operation performed by the control device (e.g., identifies data that is being read, written, or erased).

Returning to FIG. 5, if update process 216 determines that information included in any of these databases has been changed, update process 216 may generate an update message (step 504). An update message may include information associated with the detected change. Update process 216 may generate an update message that includes the identification of the database that stores the changed information and/or data associated with the changed information (e.g., memory location, title (i.e., product type, rule type, etc.), etc. For example, if supplier is an airline and the change to one of the databases 210-214 corresponds to a new reservation or sale of a airline ticket, the update message may include information associated with the flight number and type of seat sold or reserved (e.g., economy, business, or first class). Further, for example, if a standard rule stored in database 212 is modified by seller system 102, such as a condition or parameter value, update process 216 may include in a corresponding update message information associated with the changed condition or parameter value (e.g., identifying the conditions or parameters that has changed and their corresponding values). Alternatively, update process 216 may include in the corresponding update message the entire updated standard rule with the new condition or parameter value.

Once an update message has been generated, update process 216 may provide the message to events computer 106 through, for example, network interface 220 (step 506). Alternatively, update process 216 may be configured to store the update message in a memory file with other recently generated update messages and, periodically, provide the stored update messages collectively to events computer 106 as a single batch file or message.

In one aspect of the invention, inventory computer 104 may perform the update process 216 shown in FIG. 5 on a real-time basis or a periodic basis (e.g., hourly, daily, etc.) based on the type of monitoring technique implemented for step 502.

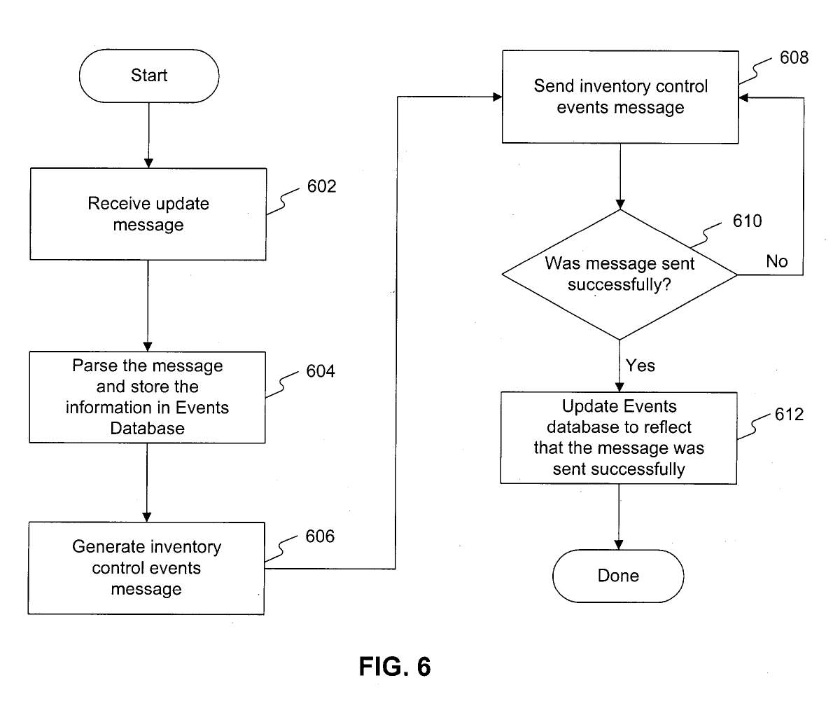

As described, inventory computer 102 may perform an update process 216 that generates one or more update messages including information reflecting any changes to data included in databases 210, 212, and/or 214. The one or more update messages maybe provided to events computer 106 to further processing consistent with certain embodiments related to the present invention. FIG. 6 shows a flowchart of a process that may be performed by events process 312 when executed by processor 302. Events process 312 may perform the steps shown in FIG. 6, without regard to the illustrated order, on a real-time basis or on a periodic basis (e.g., hourly, daily, etc.). As shown, events process 312 may begin upon receiving an update message from inventory computer 104 (step 602). The received message may be parsed by events process 312 to collect the information stored within the message. Subsequently, events process 312 stores the parsed information in events database 310 (step 604).

At some point in time, events process 312 may generate an inventory control events message based on the information stored in events database 310 (step 606). The inventory control events message may include information associated with the detected updates reflected in the update message provided by inventory computer 104. In one aspect of the invention, an inventory control events message may include the same information included in a corresponding received update message, or alternatively include more or less information included in the update message.

Once an inventory control events message has been generated, events process 312 may provide the message to another computer, such as proxy computers 108 using, for example, an event driven messaging technique (e.g., publish and subscribe) (step 608). In one aspect of the invention, events process 312 may send the message simultaneously to a plurality of proxy computers 108. Further, events process 312 may provide the events message to a single proxy computer 108. Once skilled in the art will appreciate that number of proxy computers that receive an events message from events computer 106 may be based on the number of proxy computer implemented in system 100. For example, in one aspect of the invention, system 100 may employ a single proxy computer 108 that is configured to handle all requested from client computers 110. In this exemplary aspect, events computer 106 would provide the events message to the single proxy computer 108.

Alternatively, multiple proxy computers 108 may be grouped according to certain specifications, such as geographic location, processing capabilities, etc. For example, a group of one or more proxy computers 108 may be dedicated to handle requests from one geographic region of the United States (e.g., eastern region) and another group one or more proxy computers may be dedicated to handle requests from another geographic region (e.g., western region). One skilled in the art will appreciate that events computer 106 may use different methods to send update messages to proxy computers 108. For example, update process 216 may include a messaging process, such as MQSeries Messaging, that may create a queue on inventory computer 104 and may send the update message to this queue. In this case, events computer 106 may monitor the queue and upon detecting a message in the queue, may process the message, for example, as shown in FIG. 6, to send the information stored in this message to proxy computers 108.

In one aspect of the invention, events process 312 may determine whether the events message was successfully delivered and received by proxy computers 108 (step 610). Events process 312 may determine whether the events message was successfully delivered using one or more different message delivery verification techniques. In one aspect, events process 312 may generate and provide a query to proxy computers 108 to determine if the message was successfully received. For example, proxy computers 108 may be configured to generate a response to a delivery request indicating whether the events message was successfully delivered. Acknowledgement and non-acknowledgement type protocols may be implemented by proxy computers 108 and events computer 106 to indicate whether an events message was delivered successfully. For instance, proxy computer 108 may send events computer 106 an non-acknowledge message indicating that the events message was not successfully delivered.

Returning back to FIG. 6, if events process 312 determines that the events message was delivered successfully (step 610; NO), events process 312 may resend the message (steps 610 and 608). On the other hand, if events process 312 determines that the message was delivered successfully (step 610; YES), events process 312 may update events database 310 with an indication reflecting the successful delivery (step 612).

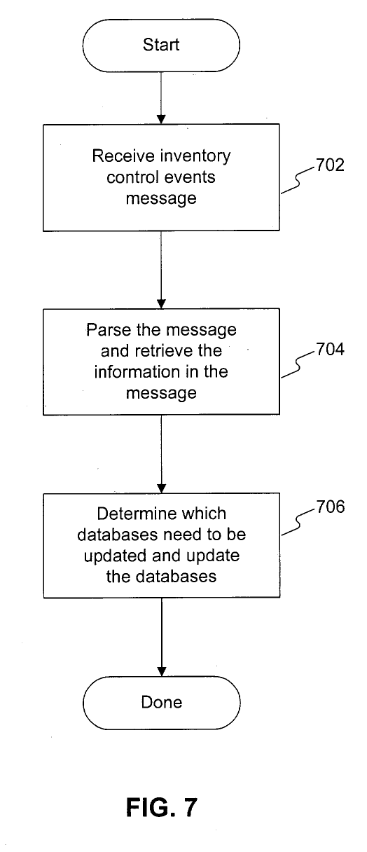

Upon receiving an inventory control events message from events computer 106, proxy computers 108 may determine which database(s) (e.g., 410, 412, and 414) is to be updated. FIG. 7 is a flowchart showing a process performed by database update process 416 when executed by processor 402. As shown, proxy computer may perform update process 416 upon receiving an inventory control events message from events computer 106 (step 702). Update process 416 may parse the message to collect the update information included in the events message (step 704). Based on the collected information, database update process 416 may determine the databases that need to be updated (step 706). Once determined, update process 416 may update the appropriate database(s) (e.g., 410, 412, and/or 414). For example, if database update process 416 determines that the events message includes information reflecting an update to a product's availability, it may update database 410 with the information associated with the availability information. Further, if update process 416 determines that databases 410 and 412 need to be updated, it may update both of these databases with the information included in the events message.

The update process 416 may be performed by proxy computer 108 on a real-time or a periodic basis (e.g., hourly, daily, etc.). For example, update process 416 may update an appropriate database 410-414 when an events message is parsed. Alternatively, update process 416 may collect a plurality of events messages, periodically parse the messages, and update appropriate databases 41-414 based on the parsed information.

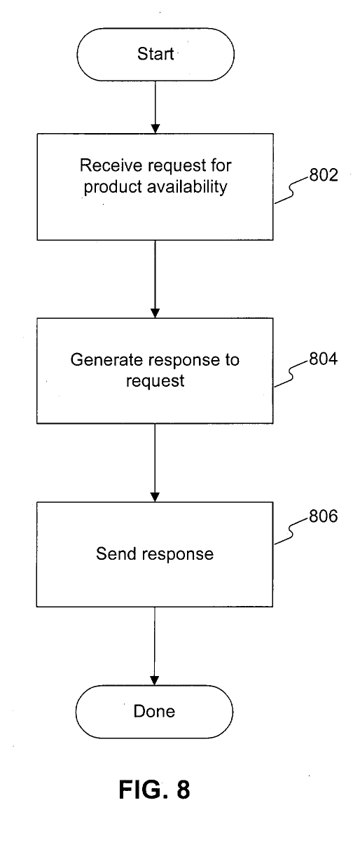

As explained in the foregoing description, availability process 417 of proxy computer 108 may generate a response to a product available information request. FIG. 8 is a flowchart showing a process performed by availability process 417 when executed by processor 402. As shown, availability process 417 may receive a request for product availability information from client computer 110 (step 802). Client 110 may generate an availability request based on input received from a user operating client 110. For example, a user may use a browser application operating on client 110 to access a web site maintained by a web server controlled by supplier 101. The web site may include information associated with one or more products provided by supplier 101. The user may be presented with a query that enables the user to formulate an availability request associated with one or more of the products. Client computer 110 may collect the information received by the user's query and formulate an availability request that is sent to proxy computer 108.

Upon receiving an availability request, availability process 417 may generate a response to the request using the information stored in one or more of databases 410, 412, and 414 (step 804). Once a response has been generated, proxy computer 108 may formulate a response message including the availability response and provide the response message to client computer 110 (step 806).

The availability response generated by proxy computer 108 may be identical to a response that would have been generated by a response process that performed by supplier system 102. Alternatively, however, the response generated by proxy computer 108 may include information that would not be included by supplier system 102. In one aspect of the invention, the availability response generated by proxy computer 108 may be based on a process (e.g., algorithm) or one or more inventory control rules that is not used by supplier system 102. For example, if supplier 101 is associated with an airline, the response generated by proxy computer 108 may take into account point of sale information, such as a travel agent identification number and/or frequent flyer identification number of the user formulating the availability request.

In addition to the availability information included in database 410, proxy computer 108 may generate a response using one or more control rules included in databases 412 and 414. To further illustrate how proxy computer 108 may formulate an availability response, consider the following example. Assume that supplier 101 is an airline that provides air travel services. Each flight of an air travel service may be associated with one or more available seats at varying costs. For example, suppose an exemplary flight is scheduled to leave Washington-Dulles airport located outside of Washington D.C. at 9:00 AM on a certain date and arrive in San Francisco, Calif. at 2:30 P.M. on the same date. Further suppose that a user operating client computer 110 generates a request requesting the availability of any seats associated with this flight and provides the request to proxy computer 108. Based on the update processes and one or more control rules consistent with certain aspects of the invention, proxy computer 108 may include information on available seats in database 410. Accordingly, availability process 417 may access database 410 to identify any of one or more classes of available seats on the exemplary flight, the cost of the seats within each seat class, the class of service, etc. Alternatively, availability process 417 may identify one or more particular products, such as one or more available seats within a particular flight. Further, availability process 417 may access databases 412 and 414 to determine and apply any appropriate control rules associated with the exemplary flight. A response may then be generated based on the accessed information. For example, a control rule may adjust the price of an available seat on the exemplary flight based on a determined revenue for previously booked seats for the flight (e.g., the difference between the cost of the flight to travel from Washington-Dulles to San Francisco and the revenue generated from the seats already sold). Subsequently, availability process 417 may provide the response including the available seat and the adjusted price in a message to the user via network 116.

Deployment of Proxy Computers 108

A proxy computer 108 may be configured and deployed by suppler 101 or by a third party entity, such as a travel service distribution entity. In one aspect of the invention, supplier 101 may develop the software that is used to control a proxy computer 108 (e.g., availability process 417, update process 416, and/or the control rules stored in databases 412 and 414. Supplier 101 may use supplier system 102 to provide the developed software to a computer system to create a proxy computer 108. Once the proxy computer 108 is created and deployed (e.g., running and accepting availability requests), supplier 101 may adjust the rules, parameters, and availability processes running on proxy computer 108 by providing software that updates or changes this information through supplier system 102. Accordingly, a supplier 101 may customize a proxy computer 108 to handle availability requests from one or more client computers 110 based on the types of products offered by supplier 101.

Supplier 101 may configure a proxy computer 108 in such a manner that the proxy is compatible with dynamically configurable platforms. For instance, technologies that may be incorporated within a proxy computer 108 may include Enterprise Java Beans (EJBs), commodity servers (Unix, Linux, Windows/NT, and Internet-based messaging server-based systems. Information that a proxy computer 108 may need to formulate accurate availability response may be delivered by supplier computer 102 in near real-time. Thus, an airline may ensure that its one or more proxy computers 108 operating on behalf of supplier computer 102 include current information associated with airline seats sold, current fare process, and other airline-based information that needs to be updated on a real-time basis.

The above-noted features, other aspects, and principles of the present invention may be implemented in various system or network configurations to provide automated and computational tools for providing product availability information. Such configurations and applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to an article of manufacture such as computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. The media may take many forms including, but not limited to, non-volatile media, volatile media, and transmission media. Non-volatile media includes, for example, optical or magnetic disks. Volatile media includes, for example, dynamic memory. Transmission media includes, for example, coaxial cables, copper wire, and fiber optics. Transmission media can also take the form of acoustic or light waves, such as those generated during radio-wave and infra-red data communications. Examples of program instructions include both machine code, such as produced by compiler, and files containing a high level code that can be executed by the computer using an interpreter.

Furthermore, it will be apparent to those skilled in the art that various modifications and variations can be made in the system and method of the present invention and in construction of this invention without departing from the scope or spirit of the invention. For example, it will be apparent to one skilled in the art that multiple instances of a process (e.g., availability process 417) may run on a computer in system 100.

Moreover, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing product availability information to a requester in a distributed system including a seller computer that provides product inventory information and a proxy computer for processing data on behalf of the seller computer, the method, performed by the proxy computer, comprising:
receiving product inventory information from the seller computer and storing the product inventory information locally in a memory associated with the proxy computer in advance of receiving any requests for product availability information;
receiving a request for product availability information from a requester;
determining the product availability information based on the product inventory information received from the seller computer without accessing the seller computer; and
providing the product availability information to the requestor.

2. The method of claim 1, further comprising:
receiving a control rule generated by the seller computer.

3. The method of claim 2, wherein determining the product availability information includes:
determining the product availability information based on the product inventory information and the control rule.

4. The method of claim 1, wherein the proxy computer includes a control rule provided by the seller computer and the method further comprises:
receiving a parameter value associated with the control rule provided by the seller computer; and
replacing an existing parameter value associated with the control rule with the received parameter value.

5. The method of claim 1, wherein receiving product inventory information includes:
receiving the product inventory information based on a determination that corresponding product inventory information stored on a database is being adjusted by the seller computer.

6. The method of claim 1, wherein the product inventory information reflects information associated with an travel related service and the product availability information reflects information associated with one or more available opportunities to receive the travel related service.

7. The method of claim 6, wherein the travel related service is one of an airline flight, a ship voyage, a train trip, a bus trip, a limousine trip, and a lodging service.

8. The method of claim 1, wherein the product availability information determined by the proxy computer is identical to product availability information that would have been generated by the seller computer had the seller computer received the request.

9. The method of claim 1, further comprising:
maintaining the product inventory information in the proxy computer up to date with product inventory information maintained by the seller computer.

10. The method of claim 1, further comprising:
ensuring that the product inventory information locally stored in the memory is substantially not out of date with product inventory information provided by the seller computer.

11. A method for providing product availability information in a distributed system including an events computer and a proxy computer that acts on behalf of a seller computer that provides product inventory information, the method performed by the events computer, comprising:
receiving the product inventory information provided by the seller computer;
generating an events message including the received product inventory information; and
providing the events message to the proxy computer such that the proxy computer uses the product inventory information included in the events message to determine product availability information in response to an availability request received at the proxy computer.

12. The method of claim 11, wherein receiving product inventory information includes:
receiving a control rule provided by the seller computer.

13. The method of claim 12, wherein generating the events message includes:
generating the events message including the product inventory information and the received control rule.

14. The method of claim 13, wherein determining the product availability information includes:
determining the product availability information based on the product inventory information and the control rule.

15. The method of claim 11, wherein the proxy computer includes a control rule provided by the seller computer and receiving product inventory information further comprises:
receiving a parameter value associated with the control rule provided by the seller computer.

16. The method of claim 15, wherein generating an events message includes:
generating an events message including the product inventory information and the received parameter value, wherein the proxy computer replaces an existing parameter value associated with the control rule with the received parameter value included in the events message.

17. The method of claim 11, wherein receiving product inventory information includes:
receiving the product inventory information based on a determination that corresponding product inventory information stored on a database is being adjusted by the seller computer.

18. The method of claim 11, wherein the product inventory information reflects information associated with an travel related service and the product availability information reflects information associated with one or more available opportunities to receive the travel related service.

19. The method of claim 18, wherein the travel related service is one of an airline flight, a ship voyage, a train trip, a bus trip, a limousine trip, and a lodging service.

20. The method of claim 11, wherein the product availability information determined by the proxy computer is identical to product availability information that would have been generated by the seller computer had the seller computer received the request.

21. The method of claim 11, wherein the product inventory information included in the events message is substantially up to date with product inventory information provided by the seller computer.

22. A method for receiving product availability information in a distributed system including a client computer and a proxy computer that processes data on behalf of a seller computer, the method performed by the client computer, comprising:
providing to the proxy computer a request for product availability information; and
receiving, from the proxy computer, the product availability information, wherein the proxy computer determines, without accessing the seller computer, the product availability information based on product inventory information stored at the proxy computer that was previously provided by the seller computer.

23. The method of claim 22, wherein the proxy computer includes a control rule provided by the seller computer and the product availability information is based on the stored product inventory information and the control rule.

24. The method of claim 23, wherein the control rule includes a parameter that is updated by the proxy computer when the seller computer updates a parameter for a corresponding control rule stored in a remote database.

25. The method of claim 22, wherein the product inventory information reflects information is associated with an travel related service and the product availability information reflects information associated with one or more available opportunities to receive the travel related service.

26. The method of claim 23, wherein the travel related service is one of an airline flight, a ship voyage, a train trip, a bus trip, a limousine trip, and a lodging service.

27. The method of claim 22, wherein the product availability information determined by the proxy computer is identical to product availability information that would have been generated by the seller computer had the seller computer received the request.

28. The method of claim 22, wherein the product inventory information stored at the proxy computer is substantially up to date with product inventory information provided by the seller computer.

29. A system for providing product availability information, comprising:
a client computer for providing an availability request associated with a product provided by a supplier;
a seller system for providing a control rule and inventory information associated with the product; and
a proxy computer for maintaining a copy of the inventory information and the control rule and acting on behalf of the seller system to provide product availability information in response to the availability request based on at least one of the copies of the inventory information and the control rule,
wherein the proxy computer is configured to update the copy of the inventory information based on a determination that the seller computer has updated the product inventory information.

30. The system of claim 29, further comprising:
an inventory computer for storing the product inventory information and control rule provided by the seller computer and determining whether the seller computer has updated at least one of the product inventory information and control rule.

31. The system of claim 30, wherein the inventory computer is configured to provide an update message including information reflecting the updated at least one of the product inventory information and control rule based on the determination.

32. The system of claim 31, further including:
an events computer for receiving the update message and providing the updated at least one of the product inventory information and control rule to the proxy computer.

33. The system of claim 29, wherein the control rule includes a parameter and the proxy computer is configured to update a corresponding parameter for the copy of the control rule when the seller computer updates the parameter.

34. The system of claim 29, wherein the product inventory information reflects information associated with an travel related service and the product availability information reflects information associated with one or more available opportunities to receive the travel related service.

35. The system of claim 34, wherein the travel related service is one of an airline flight, a ship voyage, a train trip, a bus trip, a limousine trip, and a lodging service.

36. The system of claim 29, wherein the product availability information provided by the proxy computer is identical to product availability information that would have been generated by the seller computer had the seller computer received the request.

37. A system for processing data on the behalf of a seller computer that provides product inventory information to provide product availability information, the system comprising:
means for receiving product inventory information from the seller computer and storing the product inventory information in a local memory in advance of receiving any requests for product availability information;
means for receiving a request for product availability information from a requester;
means for determining the product availability information based on the product inventory information received from the seller computer and without accessing the seller computer; and
means for providing the product availability information to the requestor.

38. The system of claim 37, further comprising:
means for receiving a control rule generated by the seller computer.

39. The system of claim 38, wherein the means for determining the product availability information includes:
means for determining the product availability information based on the product inventory information and the control rule.

40. The system of claim 37, further including:
means for storing a control rule provided by the seller computer;
means for receiving a parameter value associated with the control rule provided by the seller computer; and
means for replacing an existing parameter value associated with the control rule with the received parameter value.

41. The system of claim 37, wherein the means for receiving product inventory information includes:
means for receiving the product inventory information based on a determination that corresponding product inventory information stored on a database is being adjusted by the seller computer.

42. The system of claim 37, wherein the product inventory information reflects information associated with an travel related service and the product availability information reflects information associated with one or more available opportunities to receive the travel related service.

43. The system of claim 42, wherein the travel related service is one of an airline flight, a ship voyage, a train trip, a bus trip, a limousine trip, and a lodging service.

44. The system of claim 37, wherein the determined product availability information is identical to product availability information that would have been generated by the seller computer had the seller computer received the request.

45. The system of claim 37, further comprising:
means for maintaining the product inventory information in the proxy computer up to date with product inventory information maintained by the seller computer.

46. The system of claim 37, further comprising:
means for ensuring that the product inventory information stored in the local memory is substantially not out of date with product inventory information provided by the seller computer.

47. A system for providing product availability information, comprising:
means for receiving product inventory information provided by a seller computer;
means for generating an events message including the product inventory information; and
means for providing the events message to a proxy computer such that the proxy computer uses the product inventory information to determine product availability information in response to an availability request received at the proxy computer.

48. The system of claim 47, wherein the means for receiving product inventory information includes:
means for receiving a control rule provided by the seller computer.

49. The system of claim 48, wherein the means for generating the events message includes:
means for generating the events message including the product inventory information and the received control rule.

50. The system of claim 48, wherein the means for determining the product availability information includes:
means for determining the product availability information based on the product inventory information and the control rule.

51. The system of claim 47, wherein the proxy computer includes a control rule provided by the seller computer and the means for receiving product inventory information further comprises:
means for receiving a parameter value associated with the control rule provided by the seller computer.

52. The system of claim 51, wherein the means for generating an events message includes:
means for generating an events message including the product inventory information and the received parameter value, wherein the proxy computer replaces an existing parameter value associated with the control rule with the received parameter value included in the events message.

53. The system of claim 47, wherein the means for receiving product inventory information includes:
means for receiving the product inventory information based on a determination that corresponding product inventory information stored on a database is being adjusted by the seller computer.

54. The system of claim 47, wherein the product inventory information reflects information associated with an travel related service and the product availability information reflects information associated with one or more available opportunities to receive the travel related service.

55. The system of claim 51, wherein the travel related service is one of an airline flight, a ship voyage, a train trip, a bus trip, a limousine trip, and a lodging service.

56. The system of claim 47, wherein the product availability information determined by the proxy computer is identical to product availability information that would have been generated by the seller computer had the seller computer received the request.

57. A computer-readable medium including instructions for performing a method, when executed by a processor, for providing product availability information to a requester in a distributed system including a seller computer that provides product inventory information and a proxy computer for processing data on behalf of the seller computer, the method performed by the proxy computer, the method comprising:
receiving product inventory information from the seller computer and storing the product inventory information locally in a memory associated with the proxy computer in advance of receiving any requests for product availability information;
receiving a request for product availability information from a requester;
determining the product availability information based on the product inventory information received from the seller computer without accessing the seller computer; and
providing the product availability information to the requestor.

58. The computer-readable medium of claim 57, wherein the method further comprises:
receiving a control rule generated by the seller computer.

59. The computer-readable medium of claim 58, wherein determining the product availability information includes:
determining the product availability information based on the product inventory information and the control rule.

60. The computer-readable medium of claim 57, wherein the proxy computer includes a control rule provided by the seller computer and the method further comprises:
receiving a parameter value associated with the control rule provided by the seller computer; and
replacing an existing parameter value associated with the control rule with the received parameter value.

61. The computer-readable medium of claim 57, wherein receiving product inventory information includes:
receiving the product inventory information based on a determination that corresponding product inventory information stored on a database is being adjusted by the seller computer.

62. The computer-readable medium of claim 57, wherein the product inventory information reflects information associated with an travel related service and the product availability information reflects information associated with one or more available opportunities to receive the travel related service.

63. The computer-readable medium of claim 61, wherein the travel related service is one of an airline flight, a ship voyage, a train trip, a bus trip, a limousine trip, and a lodging service.

64. The computer-readable medium of claim 57, wherein the product availability information determined by the proxy computer is identical to product availability information that would have been generated by the seller computer had the seller computer received the request.

65. The method of claim 57, wherein the method further comprises:
maintaining the product inventory information in the proxy computer up to date with product inventory information maintained by the seller computer.

66. The method of claim 57, wherein the method further comprises:
ensuring that the product inventory information locally stored in the memory is substantially not out of date with product inventory information provided by the seller computer.

67. A computer-readable medium including instructions for performing a method, when executed by a processor, for providing product availability information in a distributed system including an events computer and a proxy computer that acts on behalf of a seller computer, the method performed by the events computer, the method comprising:
receiving product inventory information provided by the seller computer;
generating an events message including the product inventory information; and
providing the events message to the proxy computer such that the proxy computer uses the product inventory information to determine product availability information in response to an availability request received at the proxy computer.

68. The computer-readable medium of claim 67, wherein receiving product inventory information includes:
receiving a control rule provided by the seller computer.

69. The computer-readable medium of claim 68, wherein generating the events message includes:
generating the events message including the product inventory information and the received control rule.

70. The computer-readable medium of claim 69, wherein determining the product availability information includes:
determining the product availability information based on the product inventory information and the control rule.

71. The computer-readable medium of claim 67, wherein the proxy computer includes a control rule provided by the seller computer and receiving product inventory information further comprises:
receiving a parameter value associated with the control rule provided by the seller computer.

72. The computer-readable medium of claim 71, wherein generating an events message includes:
generating an events message including the product inventory information and the received parameter value, wherein the proxy computer replaces an existing parameter value associated with the control rule with the received parameter value included in the events message.

73. The computer-readable medium of claim 67, wherein receiving product inventory information includes:
receiving the product inventory information based on a determination that corresponding product inventory information stored on a database is being adjusted by the seller computer.

74. The computer-readable medium of claim 67, wherein the product inventory information reflects information associated with an travel related service and the product availability information reflects information associated with one or more available opportunities to receive the travel related service.

75. The computer-readable medium of claim 74, wherein the travel related service is one of an airline flight, a ship voyage, a train trip, a bus trip, a limousine trip, and a lodging service.

76. The computer-readable medium of claim 67, wherein the product availability information determined by the proxy computer is identical to product availability information that would have been generated by the seller computer had the seller computer received the request.

77. The computer-readable medium of claim 67, wherein the product inventory information is not substantially out of date with product inventory information maintained by the seller computer.

78. A computer-readable medium including instructions for performing a method, when executed by a processor, for receiving product availability information in a distributed system including a client computer and a proxy computer that process data on behalf of a seller computer, the method performed by the client computer, comprising:
providing to the proxy computer a request for product availability information; and
receiving, from the proxy computer, the product availability information, wherein the proxy computer determines, without accessing the seller computer, the product availability information based on product inventory information stored at the proxy computer that was previously provided by the seller computer.

79. The computer-readable medium of claim 78, wherein the proxy computer includes a control rule provided by the seller computer and the product availability information is based on the stored product inventory information and the control rule.

80. The computer-readable medium of claim 78, wherein the control rule includes a parameter that is updated by the proxy computer when the seller computer updates a parameter for a corresponding control rule stored in a remote database.

81. The computer-readable medium of claim 78, wherein the product inventory information reflects information is associated with an travel related service and the product availability information reflects information associated with one or more available opportunities to receive the travel related service.

82. The computer-readable medium of claim 81, wherein the travel related service is one of an airline flight, a ship voyage, a train trip, a bus trip, a limousine trip, and a lodging service.

83. The computer-readable medium of claim 78, wherein the product availability information determined by the proxy computer is identical to product availability information that would have been generated by the seller computer had the seller computer received the request.

84. The computer-readable medium of claim 78, wherein the product inventory information is up to date with product inventory information maintained by the seller computer.
